(19) United States
(12) Patent Application Publication
(10) Pub. No.: US 2004/0113739 A1
(43) Pub. Date: Jun. 17, 2004

(54) Low profile transformer

(75) Inventors: Jau-Jen Du, Taoyuan (TW); Ming Yeh, Taoyuan (TW)

Correspondence Address: BIRCH STEWART KOLASCH & BIRCH, PO BOX 747, FALLS CHURCH, VA, 22040-0747, US

(73) Assignee: Delta Electronics Inc.

(21) Appl. No.: 10/729,984

(22) Filed: Dec. 9, 2003

Related U.S. Application Data
(63) Continuation-in-part of application No. 09/730,848, filed on Dec. 7, 2000, now abandoned.

(51) Int. Cl. H01F 5/00

(52) U.S. Cl. 336/200

(57) ABSTRACT

A low profile transformer includes a first core and a second core respectively having a projection, a first printed circuit board and a second printed circuit board serving as primary windings of the transformer and having a hole for allowing the projections of the cores to penetrate therethrough, respectively, and an insulation wire wound around the projections of the cores as secondary windings of the transformer. The low profile transformer becomes smaller in size and lighter in weight and can meet the isolation safety standard and reduce the manufacturing costs. Furthermore, a variety of cores can be applied to the low profile transformer for a wide range of electrical current loading.

### FIELD OF THE INVENTION

The present invention is a continuation-in-part application of the parent application bearing Ser. No. 09/730,848 and filed on Dec. 7, 2000. The present invention is related to a low profile transformer, and, more particularly, to a low profile transformer that uses a PC board with a plurality of spiral traces as the primary windings, and uses insulation wires as the secondary windings of the low profile transformer.

### BACKGROUND OF THE INVENTION

A transformer device is a fairly important device for an electric or an electronic system. A transformer can be operated not only as a power supplier and a voltage transformer, but also as an energy storage. According to a conventional transformer, the classical wires were utilized as primary windings and secondary windings. However, because of its large area for winding the wires and isolating the wires, the conventional transformer has a high profile and occupies a big area on a PC board, thereby violating the demand for smaller and lighter transformer at present.

Referring to FIG. 1, the structure of a conventional transformer is shown. The transformer contains a couple of ferrite cores, i.e. the top ferrite core 2 and the bottom ferrite core 3, which are coupled to a bobbin 1. The primary windings and the secondary windings of the transformer are wound around the bobbin 1. The windings 11 are wound around the bobbin 1, and the edge of the windings 11 and the bobbin 1 are enveloped by an edge tape 13 and then further by an insulating tape 12. The usage of the bobbin for a transformer causes the issue of high profile. This issue results in that a transformer is still the largest and biggest component on a PC board.

On the other hand, U.S. Pat. No. 5,010,314 disclosed a low profile transformer to overcome the issue of high profile. The low profile transformer is formed by stacking the components layer by layer. Its main drawbacks are that the stacking layers are too much and its structure is too complicated. The drawbacks result in the complexity of electric design and also increase the manufacturing cost. The present invention will overcome the issue of high profile and meet the international safety standard.

### SUMMARY OF THE INVENTION

Therefore, an object of this invention is to provide a low profile transformer with a physical structure that can meet the international safety standard.

It is a further object of this invention to provide a planar transformer for avoiding too large size in the electric system.

It is yet another object of this invention to provide a low profile transformer to shorten the cycle time of production and reduce the production cost.

It is a further object of this invention to provide a low profile transformer, wherein the transformer can be available for a large range of current loading. This means that the transformer according to the present invention can use a variety of ferrite cores.

According to one aspect of the present invention, the low profile transformer includes a first core and a second core respectively having a projection, a first printed circuit board and a second printed circuit board serving as primary windings of the transformer and having a hole for allowing the projections of the cores to penetrate therethrough, respectively, and an insulation wire wound around the projections of the cores as secondary windings of the transformer, wherein the first printed circuit board, the insulation wire, and the second printed circuit board are sandwiched by the cores in order.

In addition, the low profile transformer further includes a plurality of insulating layers respectively located between the cores, the printed circuit boards, and the insulation wire to avoid a short circuit formed between the primary windings and the secondary windings.

Moreover, the low profile transformer further includes a plurality of fix rods for securing the printed circuit boards.

Preferably, the insulation wire is constructed by at least one copper sheet covered by an insulating material.

Preferably, the insulation wire is wound on a bobbin to be coupled with the printed circuit boards and the cores.

Alternatively, the insulation wire is a wire coated by a plurality of insulating layers.

Preferably, the insulation wire is made of copper sheet and directly coated on a printed circuit board as the secondary winding.

Preferably, the cores can be EE cores, El cores, ER cores, cut cores or other types of ferrite cores.

In addition, the first and second printed circuit boards have a plurality of spiral traces laid out thereon, respectively.

Further, the projections of the cores are aligned with each other after the cores are assembled with the printed circuit boards and the insulation wires to define a magnetic path.

The present invention may best be understood through the following description with reference to the accompanying drawings, in which:

### BRIEF DESCRIPTION OF THE DRAWINGS

FIG. 1 is an exploded view of a conventional transformer;

FIG. 2A is an exploded view of a low profile transformer according to the first embodiment of the present invention;

FIG. 2B is a perspective diagram of the assembled transformer of FIG. 2A viewed from one side thereof;

FIG. 2C is a perspective diagram of the assembled transformer of FIG. 2A viewed from another side thereof;

FIG. 2D is a schematic diagram of a bobbin which can be used for allowing the insulation wires to be wound thereon in the first embodiment of the present invention;

FIG. 2E is a perspective view of a low profile transformer of the first embodiment of the present invention, which specially shows the lead structure of the insulation wire;

FIG. 3 is an exploded view of a low profile transformer according to the second embodiment of the present invention;

FIG. 4 is an exploded view of a low profile transformer according to the third embodiment of the present invention;

FIG. 5 is an exploded view of a low profile transformer according to the fourth embodiment of the present invention;

FIG. 6A is a top view of another type of ferrite core which can be used in the present invention; and

FIG. 6B is a side view of the ferrite core of FIG. 6B.

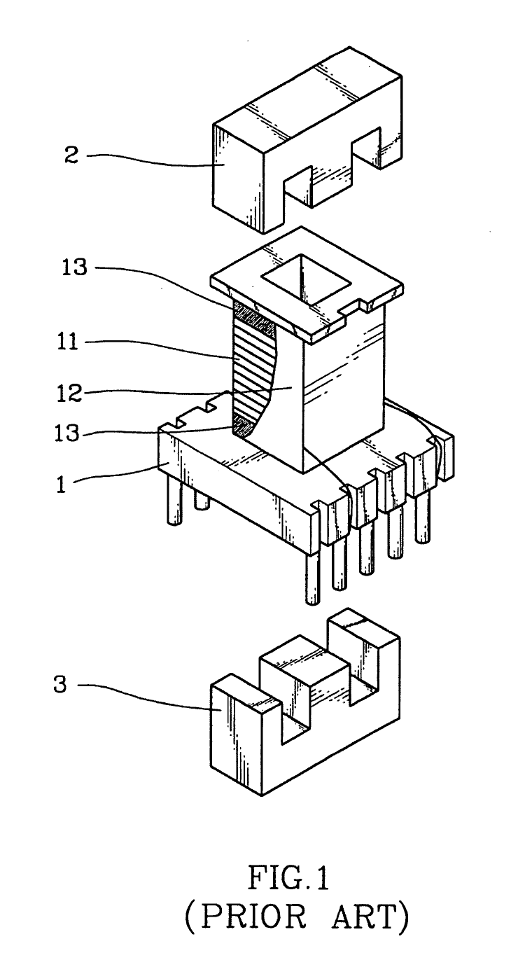

### DETAILED DESCRIPTION OF THE PREFERRED EMBODIMENT

The present invention will now be described more detailedly with reference to the following embodiments. It is to be noted that the following descriptions of the preferred embodiments of this invention are presented herein for the purpose of illustration and description only. It is not intended to be exhaustive or to be limited to the precise form disclosed.

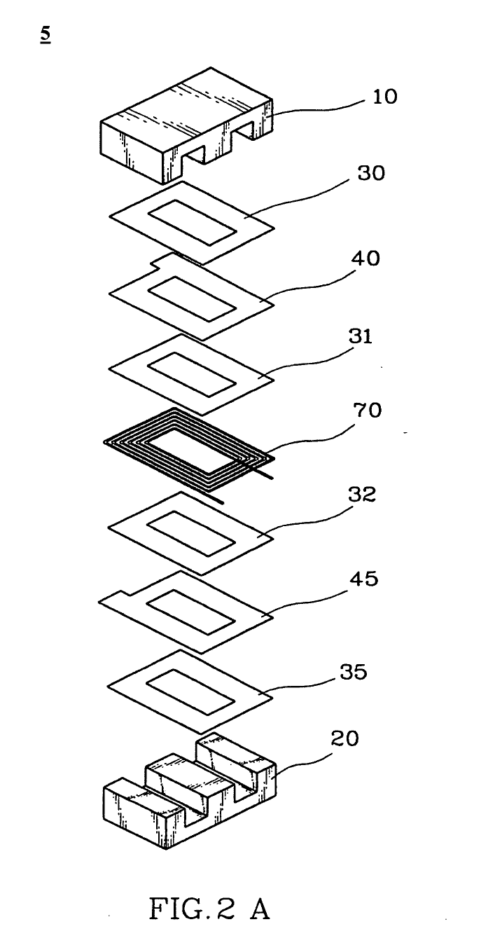

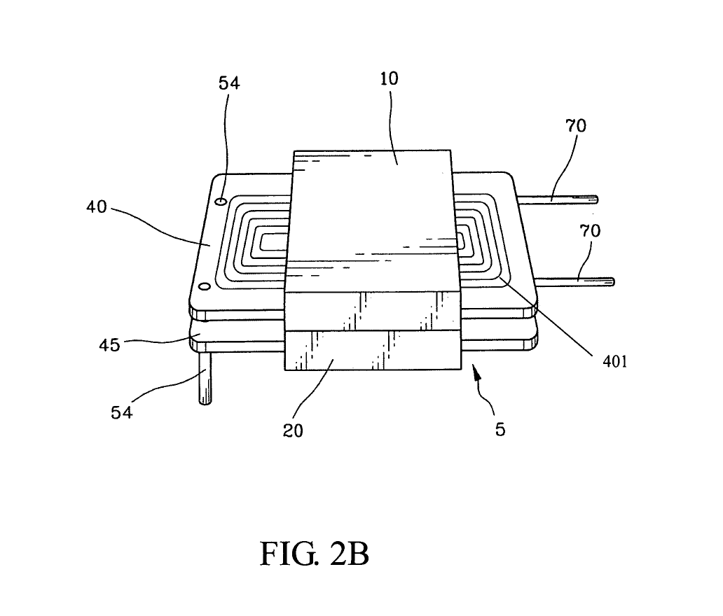

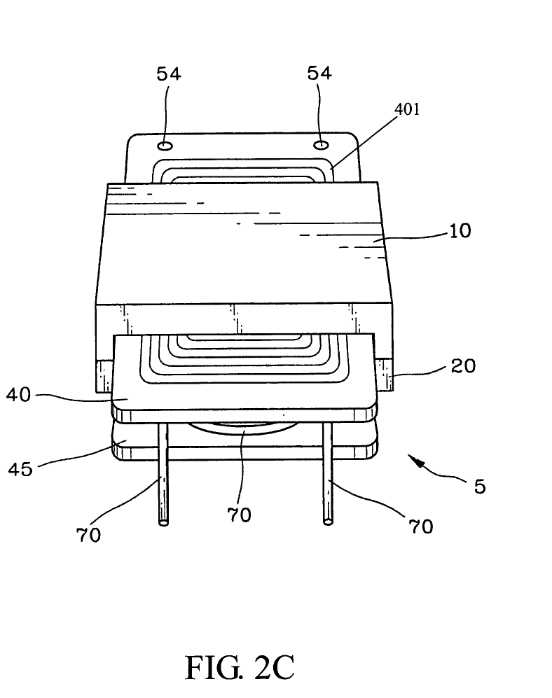

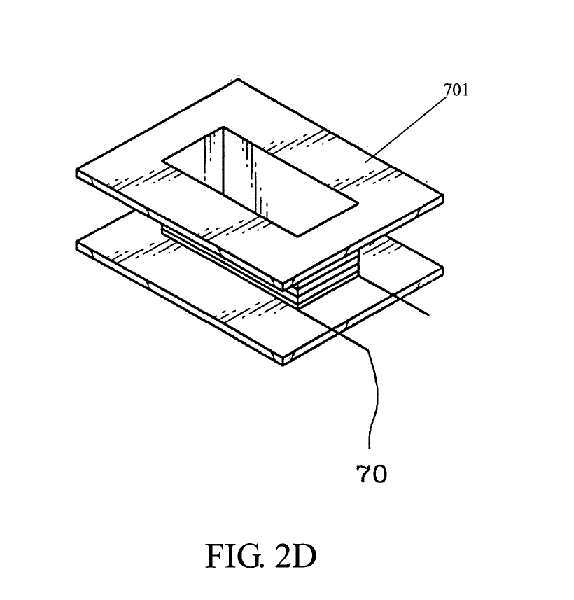

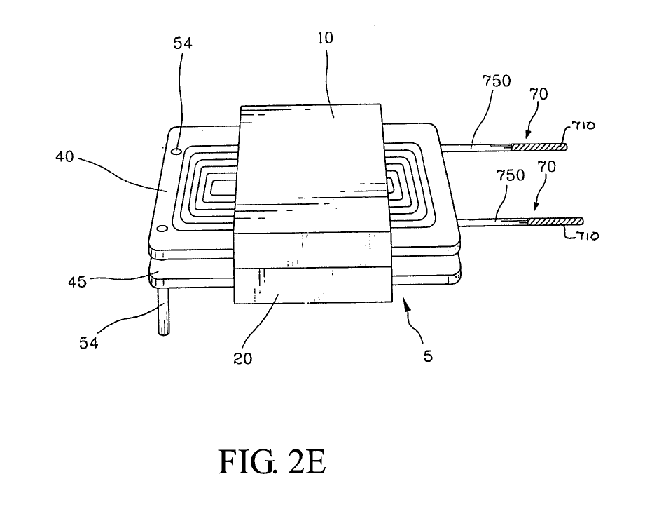

The low profile transformer of the present invention is obtained by modifying the structures of the primary windings and the secondary windings used in the prior arts. Please refer to FIGS. 2A˜2E showing the first embodiment of the transformer of the present invention, which is mainly used for the application of small current loading.

The low profile transformer 5 includes a couple of ferrite cores, i.e. the top ferrite core 10 and the bottom ferrite core 20, which are operated as a magnetic housing. Typically, the magnetic housing is made of ferrite, samarium or some other composite material that is shaped as EE core as shown in FIG. 2A. In addition, other types of ferrite cores, such as El core, ER core, ER core or cut type, are also available for the present invention.

The low profile transformer 5 shown in FIG. 2A further includes a couple of printed circuit boards (PC boards), i.e. the top PC board 40 and the bottom PC board 45. A structure of having only a PC board is also available, depending on the number of windings around the ferrite cores. A plurality of spiral traces 401 (as shown in FIG. 2B or 2C) are laid out on each PC board 40, 45 as the primary windings of the transformer 5. In order to form a low-profile structure, each PC board has a hole in the middle such that the central projections of the top ferrite core 10 and the bottom ferrite core 20 can penetrate through the holes. The transformer 5 further contains insulation wires 70 directly wound on the central projections of the top ferrite core 10 and the bottom ferrite core 20 to serve as the secondary windings. A method by using triple insulation wires wound on the ferrite cores is also available for the usage of insulation wires 70.

Alternatively, the insulation wires 70 can also be wound on a bobbin 701 in advance as shown in FIG. 2D and then assembled with other elements of the transformer.

As described above, the top PC board 40, the bottom PC board 45, and the insulation wires 70 are located between the top ferrite core 10 and the bottom ferrite core 20. Therefore, the height of the transformer is the combination of the top ferrite core 10 and the bottom ferrite core 20. Because the winding area for the primary windings is less than in the prior art, the projections length of the ferrite cores 10, 20 for the primary windings can be much shorter such that the purpose of forming a low profile transformer is achieved.

As shown in FIG. 2A, in order to prevent short-circuiting from the primary windings of the transformer to the secondary windings, the transformer further contains a plurality of insulating layers, e.g. the first, second, third and fourth insulating layers 30, 31, 32, 35, wherein the first insulating layer 30 is located between the top ferrite core 10 and the PC board 40, and the fourth insulating layer 35 is located between the bottom ferrite core 20 and the PC board 45. Certainly, the number of insulating layers is decided by actual application. Because there is already an insulating layer on the insulation wires 70, it is also available without any insulating layer. On the other hand, for further isolation, some more insulating layers 31, 32 can also be inserted into the transformer 5 above the top PC board 40 and the bottom PC board 45 respectively.

FIG. 2B depicts a side view of the first embodiment of the present invention. The spiral traces are laid out on the surfaces of the top PC board 40 and the bottom PC board 45, respectively, to serve as the primary windings of the transformer 5. Furthermore, there are a plurality of fix rods 54 on one side of the top PC board 40 and the bottom PC board 45 for fixing the top PC board and the bottom PC board.

FIG. 2C depicts a front plan view of the first embodiment of the present invention. As shown in FIG. 2C, the transformer 5 has a structure of low profile with two fix rods 54 in front of the top PC board 40 and the bottom PC board 45.

Referring to FIG. 2E, the secondary winding 70 can be triple insulation wires in order to prevent a short circuit between the primary windings and the secondary windings. The leads of the secondary windings 70 extend outwardly for a distance known as the “creepage” distance 750 in order to conform to the required safety standards. The “creepage” distance is the shortest path along the surface of insulating material between two non-insulated parts. The “creepage” distance separates the soldered portions 710 of the leads from the other uninsulated portion of the transformer.

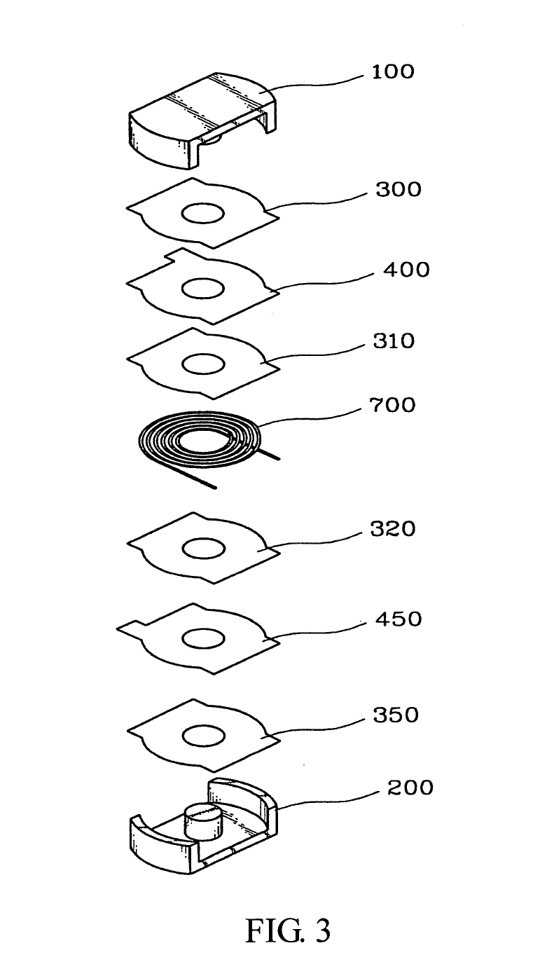

Please refer to FIG. 3 showing the second embodiment of the present invention. This transformer is almost similar to the first embodiment. The differences between these two embodiments are that the shapes of the ferrite cores 100, 200, the insulating layers 300, 310, 320, 350, the secondary winding 700 and the primary windings 400, 450 are modified, and the secondary winding 700 is three-layer insulation wires.

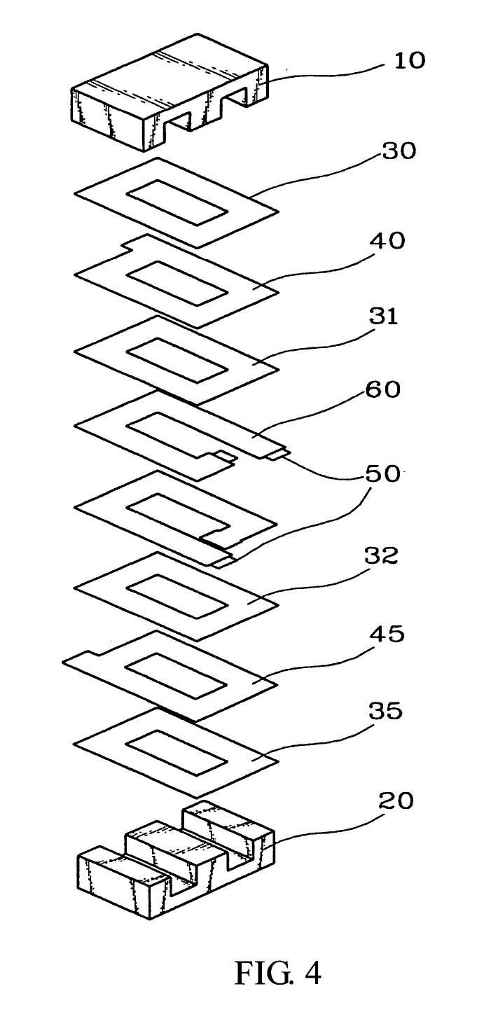

Now, please refer to FIG. 4 showing the third embodiment of the present invention, which is mainly used for the application of large current loading. The structure of this transformer is similar to the first embodiment, but a couple of copper sheets 50 are used to replace the secondary windings used in the first embodiment. Actually, the used number of the copper sheets 50 depends on the application requirement. Each copper sheet is covered by an insulating layer 60 to avoid short-circuiting to the primary windings.

As shown in FIG. 4, the top ferrite core 10 and the bottom ferrite core 20 are in the shape of cut core type. In order to match the shape of the ferrite cores 10, 20, the shape of the top PC board 40 and the bottom PC board 45 are also modified. In addition, the insulating layers 30, 35, 31, 32 are also modified to match the shape of the ferrite cores 10, 20. The spiral traces on the top PC board 40 and the bottom PC board 45 are also operated as the primary windings of the transformer just like those in the first embodiment.

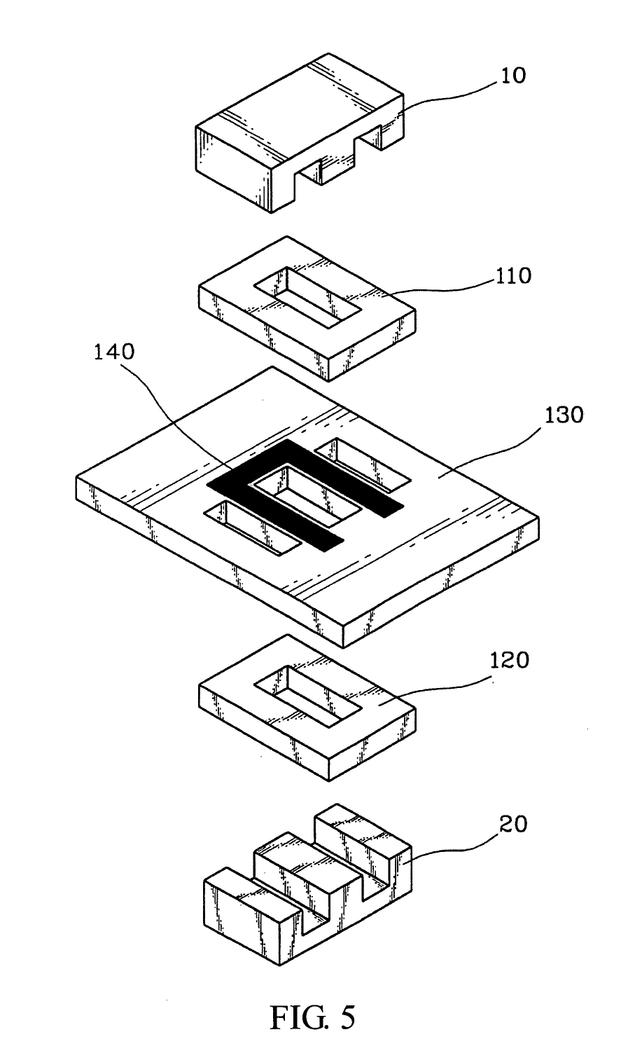

Referring now to FIG. 5, it is an exploded view of a low profile transformer according to the fourth embodiment of the present invention. The transformer includes a couple of modules, i.e. the top module 110 and the bottom module 120. There are a plurality of spiral traces located on the modules to be operated as the primary windings. There is a hole in the middle of each module such that the central projections of the top ferrite core 10 and the bottom ferrite core 20 can penetrate through the holes of the modules 110, 120.

On the other hand, the transformer 5 shown in FIG. 7 also includes a PC board 130 on which has a layout of a copper sheet circuit 140. There is also a hole in the middle of the PC board 130 such that the central projections of the top ferrite core 10 and the bottom ferrite core 20 can penetrate into the hole. The PC board 130 is located between the top module 110 and bottom module 120 and between the top ferrite core 10 and bottom ferrite core 20, and the circuit 140 on the PC board 130 are operated as the secondary windings of the transformer. As mentioned above, the top module 110 and the bottom module 120 are operated as the primary windings. After assembling the PC board 130, the modules 110, 120 and the ferrite cores 10, 20 together, the transformer according to the present invention is thus formed. In addition, one or more insulating layers can be inserted into the transformer in order to prevent short-circuiting from the primary windings to the secondary windings.

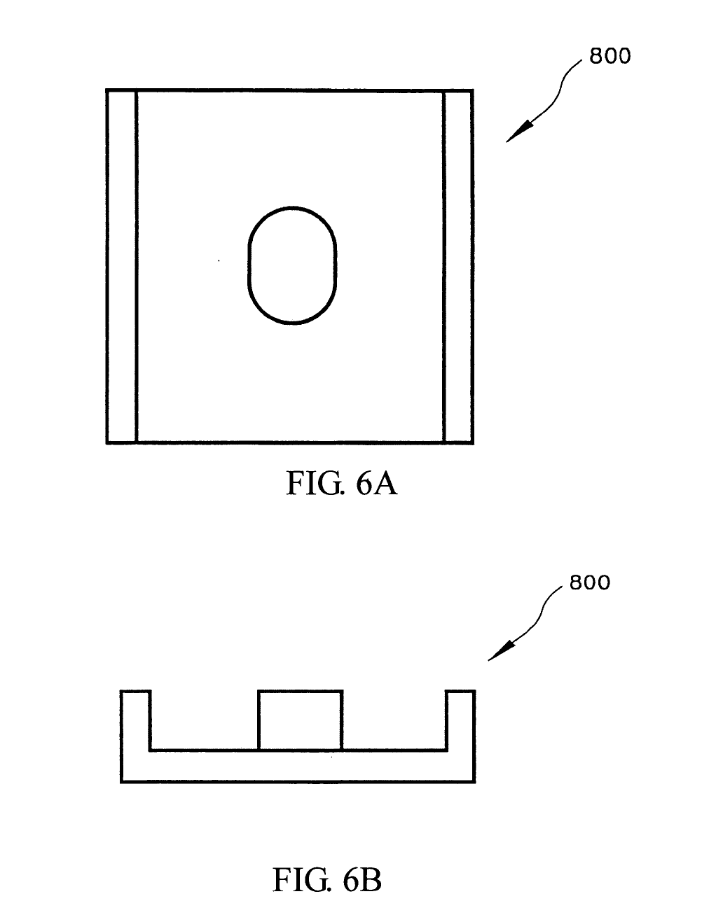

Please refer to FIGS. 6A or 6B showing another type of the ferrite core 800 for obtaining a transformer with a good performance and low energy loss.

The present invention provides a low profile transformer which is smaller in size and lighter in weight. As mentioned above, the transformer has the advantages of low profile and easy to form the primary windings and the secondary windings. The low profile transformer will meet the isolation safety standard and is manufactured with low cost.

Furthermore, a variety of ferrite cores can be applied to the low profile transformer for a wide range of electrical current loading.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A low profile transformer comprising:
a first core and a second core respectively having a projection;
at least one printed circuit board serving as primary windings of said transformer and having a hole for allowing said projections of said cores to penetrate; and
an insulation wire wound around said projections of said cores to serve as secondary windings of said transformer.

2. The low profile transformer of claim 1 wherein said at least one printed circuit board and said insulation wire are sandwiched by said cores in order.

3. The low profile transformer of claim 2 further comprising a plurality of insulating layers respectively located between said cores, said at least one printed circuit board, and said insulation wire to avoid a short circuit formed between said primary windings and said secondary windings.

4. The low profile transformer of claim 1 further comprising a plurality of fix rods for securing said at least one printed circuit board.

5. The low profile transformer of claim 1 wherein said insulation wire is constructed by at least one copper sheet covered by an insulating material.

6. The low profile transformer of claim 1 wherein said insulation wire is wound on a bobbin to be coupled with said at least one printed circuit board and said cores.

7. The low profile transformer of claim 1 wherein said insulation wire is a wire coated by a plurality of insulating layers.

8. The low profile transformer of claim 1 wherein said insulation wire is made of copper sheet and directly coated on a printed circuit board to serve as said secondary winding.

9. The low profile transformer of claim 1 wherein said first and second cores are ferrite cores selected from a group essentially consisting of EE cores, El cores, ER cores and cut cores.

10. The low profile transformer of claim 1 wherein said first and second cores are made of ferrite, samarium, metal or a mixture thereof.

11. The low profile transformer of claim 1 wherein said at least one printed circuit board has a plurality of spiral traces laid out thereon.

12. The low profile transformer of claim 1 wherein said insulation wire has a plurality of leads with soldered portions.

13. The low profile transformer of claim 1 wherein said projections of said cores are aligned with each other after said cores are assembled with said at least one printed circuit board and said insulation wires to define a magnetic path and allow said insulation wires to be directly wound thereon.

14. A low profile transformer comprising:
a first core and a second core respectively having a projection;
a first printed circuit board and a second printed circuit board disposed between said first core and said second core to serve as primary windings of said transformer, wherein said first and second printed circuit boards have a hole for allowing said projections of said cores to penetrate therethrough;
an insulation wire disposed between first printed circuit board and said second printed circuit board, and wound around said projections of said cores as a secondary winding of said transformer;
a first insulating layer located between said first core and said first printed circuit board;
a second insulating layer located between said first printed circuit board and said insulation wire;
a third insulating layer located between said second printed circuit board and said insulation wire; and
a fourth insulating layer located between said second core and said second printed circuit board.

15. The low profile transformer of claim 14 further comprising a plurality of fix rods for securing said first and second printed circuit boards.

16. The low profile transformer of claim 14 wherein said insulation wire is constructed by at least one copper sheet covered by an insulating material.

17. The low profile transformer of claim 14 wherein said insulation wire is wound on a bobbin to be coupled with said printed circuit boards and said cores.

18. The low profile transformer of claim 14 wherein said insulation wire is a wire coated by a plurality of insulating layers.

19. The low profile transformer of claim 14 wherein said insulation wire is made of a copper sheet and directly coated on a printed circuit board as said secondary winding.

20. A low profile transformer comprising:
a first core and a second core respectively having a projection;
a first printed circuit board and a second printed circuit board disposed between said first core and said second core to serve as primary windings of said transformer, wherein said first and second printed circuit boards have a hole for allowing said projections of said cores to penetrate therethrough, respectively;
an insulation wire disposed between said first printed circuit board and said second printed circuit board, and directly wound around said projections of said cores as a secondary winding of said transformer; and
a plurality of insulating layers respectively located between said first core and said first printed circuit board, said first printed circuit board and said insulation wire, said second printed circuit board and said insulation wire, or said second core and said second printed circuit board.
